(19) United States
(12) Patent Application Publication
(10) Pub. No.: US 2024/0367030 A1
(43) Pub. Date: Nov. 7, 2024

(54) SYSTEMS AND METHODS FOR LOTTERY TICKET MANAGEMENT

(71) Applicants: Lawrence MONTE, Woodland Hill, CA (US); Joseph ORLANDO, Sherman Oaks, CA (US)

(72) Inventors: Lawrence MONTE, Woodland Hill, CA (US); Joseph ORLANDO, Sherman Oaks, CA (US)

(21) Appl. No.: 18/312,005

(22) Filed: May 4, 2023

(51) Int. Cl. A63F 3/06; G07F 17/32

(52) U.S. Cl. CPC A63F 3/0645; G07F 17/323; G07F 17/3237; G07F 17/329

(57) ABSTRACT

The present disclosure provides for systems and methods for managing lottery tickets. A user may digitize one or more lottery tickets by storing images or other representations of the ticket on a computing device or cloud computer. The one or more lottery tickets may be associated with the identity of the user. The computing device or cloud computer may analyze a barcode or QR code of the ticket to extract information such as the state, sale data and time and ticket number(s), or information may be entered manually. The computing device or cloud computer may receive drawing results and may notify the user if any tickets are winning tickets. The computing device or cloud computer may associate a user proof of location or other data/metadata with the one or more tickets corresponding to location data proving user presence at a lottery vendor at the time of sale.

### TECHNICAL FIELD

The present disclosure provides for systems and methods for managing lottery tickets. A user may digitize one or more lottery tickets purchased at a lottery retailer by storing images or other representations of the ticket on a computing device or cloud computer. The one or more lottery tickets may be associated with the identity of the user. The computing device or cloud computer may analyze a barcode or QR code of the ticket to extract information such as the state, sale data and time and ticket number(s), or information may be entered manually. The computing device or cloud computer may alternatively implement optical character recognition (OCR) to input information from lottery ticket images. The computing device or cloud computer may receive drawing results and may notify the user if any tickets are winning tickets. The computing device or cloud computer may associate a user proof of location or other data/metadata with the one or more tickets corresponding to location data proving user presence at a lottery vendor at the time of sale.

### BACKGROUND

Lotteries are a popular option for gamblers. Typically, a gambler purchases and receives a ticket containing a combination of numbers and/or letters prior to a drawing that determines which combination of numbers and/or letters is winning. Lottery tickets are usually sold at physical point-of-sale (POS) locations, such as gas stations, supermarkets, and the like. While POS locations report or provide sale records to lottery authorities, such information does not typically include purchaser information. This creates a significant risk for the purchaser because their only claim to their winnings is the small paper ticket which they receive from the POS.

Annually, there are about $80 billion dollars spend on lottery tickets each year, with winnings of approximately $3 billion dollars going unclaimed annually—nearly 4%. Since 2002, there were seven unclaimed jackpots greater than $25 million dollars—six in the US and one in the UK. A Gallup survey from 2017 reported that 49% of US adults buy lottery tickets, with 56% of players earning between $36,000 and $89,999, 53% earning over $90,000 and 40% earning under $36,000. Regardless of income, lost lottery winnings is a significant problem that requires solutions compatible with the current lottery ticket marketplace.

The present invention provides for systems and methods for digitizing a user's lottery tickets, thereby addressing the problems associate with the lottery. A user's lottery tickets may be store as images associate with a user's account, in a lottery wallet. The tickets may be associated with ticket data. The systems and methods may allow for accessing lottery drawing data and for determining whether a user's lotter ticket is a winning ticket. Additionally, the methods and systems may notify the user of any wins or losses and may allow for sharing or reporting lottery results, or for claiming winnings. The improvements and embodiments herein, as a whole, may provide for a more secure and streamlined lottery experience, thereby protecting both consumers and lotteries.

### SUMMARY

The present disclosure generally provides for systems and methods for lottery ticket management While it should be apparent, the provided disclosure describes various features and attributes of various embodiments of such systems and methods. It can be appreciated that such features and attributes may advantageously be incorporated in various embodiments without departing from the scope of the disclosure

In an embodiment, the present disclosure provides for a lottery ticket management system, comprising: a mobile computing device configured to communicate with a cloud computer; the cloud computer configured to validate user credentials for access to a user account; a connection, by one or both of the mobile computing device or cloud computer, to a lottery result server; an application running on the mobile computing device, the application configured to: accept user credentials to access a user account; load, from storage, or capture, from a camera of the mobile computing device, one or more images of a lottery ticket having lottery ticket drawing numbers; associate the lottery ticket drawing numbers with the user account; retrieve lottery results from the lottery result server; determine, by comparing the lottery ticket drawing numbers to the lottery results, whether a lottery ticket number is a winning lottery ticket number; and notify the user if the lottery ticket drawing numbers are winning numbers.

In an embodiment, the cloud computer including one or more servers configured to receive lottery ticket images or lottery ticket data from the mobile computing device.

In an embodiment, the cloud computer stores lottery ticket images or lottery ticket data in a data store.

In an embodiment, the one or more images of a lottery ticket are associated with a time and date of a clock of the mobile computing device or cloud computer.

In an embodiment, the one or more images of a lottery ticket are associated with a time and date of a clock of the lottery result server.

In an embodiment, a clock of the application and/or cloud computer are synced to a clock of the lottery result server.

In an embodiment, proof of location data from a GPS of the mobile computing device is associated with the images of a lottery ticket.

In an embodiment, the lottery ticket drawing numbers are associated with the user account by optical character recognition of the images, or by accessing a lottery server by a barcode or QR code on the lottery ticket, to obtain lottery ticket data including the lottery ticket drawing numbers.

In an embodiment, the mobile computing device or cloud computer are in communication with a blockchain to store lottery ticket images or lottery ticket data as a non-fungible token associated with a digital wallet of the user, wherein the digital wallet of the user is associated with the user account of the application.

In an embodiment, the lottery ticket data, including the lottery ticket drawing numbers, are stored as image metadata.

In an embodiment, the user account is associated with official user identification (ID card).

In an embodiment, the disclosure provides for a method comprising: providing access to a user account within a lottery application, the lottery application running on a mobile computing device; inputting one or more images of a lottery ticket for a respective lottery drawing into the lottery application from the mobile computing device or a camera of the mobile computing device; determining, from the one or more images, lottery ticket drawing numbers associating respective drawing numbers of the one or more images with the user account; retrieving lottery drawing results for the lottery drawing; comparing the lottery ticket drawing numbers to the lottery drawing results to determine whether the lottery ticket is a winning ticket; and notifying the user if the lottery ticket is a winning ticket.

In an embodiment, the lottery ticket drawing numbers are determined from the one or more images by optical character recognition, or by accessing a lottery server using a barcode or QR code on the lottery ticket.

In an embodiment, the lottery tickets are associated with the user account prior to a lottery drawing to establish ownership prior to the drawing.

In an embodiment, the method further comprises a step of the user electronically signing an image of the back of the lottery ticket.

In an embodiment, the input images further include one or both of clock or GPS proof of location data.

In an embodiment, the method further comprises a step of claiming winnings from a winning lottery ticket by communication with a lottery server.

In an embodiment, the present disclosure provides for a lottery ticket purchasing and management system, comprising: a mobile computing device configured to communicate with a cloud computer; a point-of-sale (POS) terminal configured to display a barcode or QR code associated with one or more lottery tickets purchased at the POS; the cloud computer configured to validate user credentials for access to a user account; an application running on the mobile computing device, the application configured to:
accept user credentials to access a user account; scan, from a camera of the mobile computing device, a barcode or QR code displayed on the POS terminal, to associate the user account with the one or more lottery tickets purchased at the POS.

In an embodiment, the application is further configured to: access from the cloud computer or POS terminal, or capture using the camera of the mobile computing device, one or more images of a lottery ticket having lottery ticket drawing numbers; and associate the lottery ticket drawing numbers with the user account.

In an embodiment, the system further comprises a connection, by one or both of the mobile computing device or cloud computer, to a lottery result server.

In an embodiment, the mobile computing device and application are configured to: retrieve lottery results from the lottery result server; determine, by comparing the lottery ticket drawing numbers to the lottery results, whether a lottery ticket number is a winning lottery ticket number; and notify the user if the lottery ticket drawing numbers are winning numbers.

In an embodiment, scanning the barcode or QR code instructs the mobile computing device and application to automatically capture one or more proofs-of-location.

In an embodiment, the proofs-of-location include one or more of time, date, and GPS location.

In an embodiment, scanning the barcode or QR code instructs the mobile computing device and application to automatically transmit a user ID to one or more of a store computer, POS terminal, cloud computer, or lottery server to verify the user's presence at the POS.

In an embodiment, the terminal is a self-service terminal.

In an embodiment, the self-service terminal includes a camera, and wherein the self-service terminal takes an image of the user for proof-of-location at the time of ticket purchase.

These and other embodiments are described further herein.

### BRIEF DESCRIPTION OF THE DRAWINGS

Aspects and advantages of the present disclosure will become apparent from the following exemplary embodiments taken in conjunction with the accompanying drawings, of which:

FIG. 1 depicts an exemplary embodiment depicting a mobile computing device and associated cloud computer;

FIG. 2 depicts a schematic view of an exemplary mobile computing device;

FIG. 3 depicts and exemplary schematic view of a cloud computer;

FIG. 4 depicts an exemplary embodiment where a cloud computer receives and processes images and data from a mobile computing device;

FIG. 5 depicts an exemplary embodiment where a mobile computing device communicates data to a cloud computer;

FIG. 6A depicts an exemplary embodiment where a cloud computer is in communication with a blockchain for storage of images and/or data;

FIG. 6B depicts an exemplary embodiment where a mobile computing device is in communication with a blockchain for storage of images and/or data;

FIG. 7 depicts an exemplary embodiment of an application environment;

FIG. 8 depicts exemplary lottery application methods;

FIG. 9 depicts exemplary logic for a lottery application; and

FIG. 10 depicts an exemplary point-of-sale (POS) embodiment.

### DETAILED DESCRIPTION

As described herein the present disclosure generally provides for systems and methods for improved lottery play. In most states, a player must purchase a paper lottery ticket using cash, which is otherwise not linked to their person or identity. A vendor may verify the player's age using their ID, but their identification is not typically associated with the lottery ticket or assigned lottery numbers. Therefore, players are placed in a precarious situation of holding a piece of paper which is potentially worth millions of dollars. Even after the drawing occurs, typically up to a few days after ticket purchase, the player must continue to hold onto the ticket before claiming their prize. Due to legalities and identity concerns, the player may wait several months before claiming their prize due to the necessary legal and financial planning associated with a winning ticket. There are no currently-existing solutions to this problem that could result a life-altering loss of deserved winnings and assets.

In an embodiment, the present disclosure provides for systems and methods for digitizing a lottery ticket. The term “digitizing” as used herein does not simply mean converting a paper lottery ticket to a stored image or other digital representation. Rather, the term “digitizing” encompasses an association of a lottery ticket and associated data with a verified and secure user account, and storing the lottery ticket and associated data in a verifiable format to prove ownership of the lottery ticket. In additional embodiments, the systems and methods provide for extracting ticket information and verifying certain aspects including drawing date/time, whether a lottery drawing has taken place, whether a lottery drawing result has been officially verified, whether a ticket or loses, expected payout values, and for notifying the user and/or other individuals which the user would wish to notify. The systems and methods may further include point-of-sale (POS) verification features such as GPS-enabled time and place of purchase verification (not requiring any POS functions), POS-enabled time and place of purchase verification, or other proof of purchase features associating the purchased lottery ticket with the account holder. These and further embodiments should become clear from the following exemplary system and method embodiments.

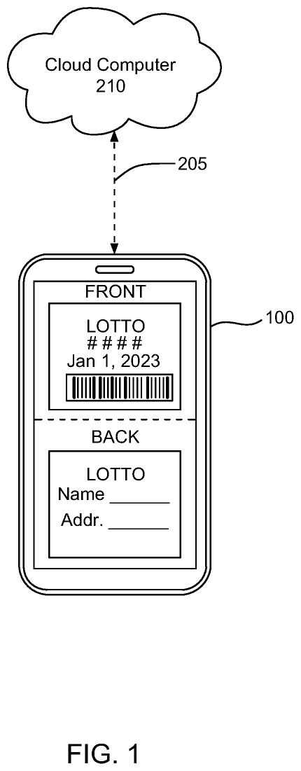

FIG. 1 depicts an exemplary embodiment showing a mobile communication device 100 in communication 205 with a cloud computer 210. In some embodiments, the communication 205 is wireless (Wi-Fi, cellular, Bluetooth, etc.). In alternative embodiments, the communication 205 may be wired. Generally, however, the mobile communication device has wireless capabilities. The cloud computer 210 may be any remote server or server(s) with which the mobile communication device 100 may communicate via standard communication gateways and protocols (not shown). The cloud computer 210 is generally capable of receiving and storing information from the mobile computing device 100 and may further provide various processing functions as described in further exemplary embodiments. In an embodiment, the mobile computing device 100 is a cellular phone, cellphone, mobile phone, etc. In an alternative embodiment, the mobile computing device 100 is a smartwatch, tablet, laptop computer, or any other appropriate computing device.

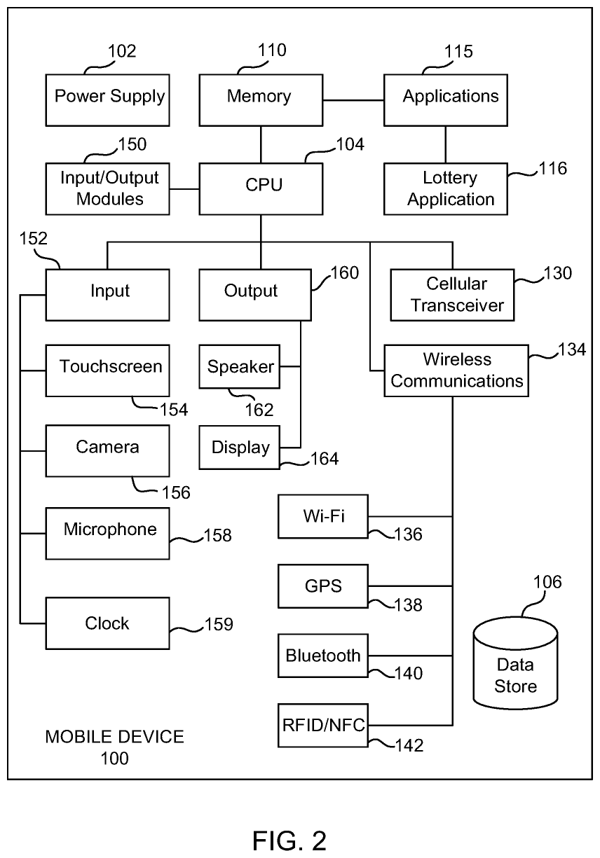

FIG. 2 depicts an exemplary schematic of a mobile computing device 100. In an embodiment, the mobile computing device 100 has at least those features necessary to perform the various described embodiments as would be appreciated by a person of skill in the art. In general, the mobile computing device 100 has one or more of the features described in FIG. 2. In an embodiment, the mobile computing device has a power supply 102 (such as a battery), a processor 104, volatile memory 110, non-volatile memory (i.e. a data store) 106, input/output modules 150, and a power supply 102. In an embodiment, the data store 106 includes one or more applications for 115 including the described lottery application 116. Aspects of the applications are generally run by the processor 104 and memory 110, in conjunction with non-volatile storage 106.

The mobile computing device 100 includes various input/output modules 150 or features. In an embodiment, the mobile computing device 100 may include certain input 152 modules, including a touchscreen 154, camera 156, microphone 158, and clock 159. The clock 159 is intended to include both date and time and may be set by the cellular carrier network. In an alternative embodiment, the clock 159 is based on the cloud computer clock or, alternatively, lottery result server clock. It can be appreciated that a touchscreen 154 provides for a virtual keyboard for entry of information. In various embodiments, the touchscreen 154 is substituted for a physical keyboard, buttons, or any other means for entering data. In an embodiment, the mobile computing device 100 may include certain output modules 160, including a speaker 162 and display 164. The mobile computing device 100 may include a cellular transceiver 130 capable of communicating with cellular towers for the transmission of voice, SMS or MMS text, or other data. In other embodiments, the mobile computing device 100 may include various wireless communications 134 including Wi-Fi 136, GPS 138 and Bluetooth 140. In further embodiments, the mobile communication device 100 may include RFID/NFC capabilities 142.

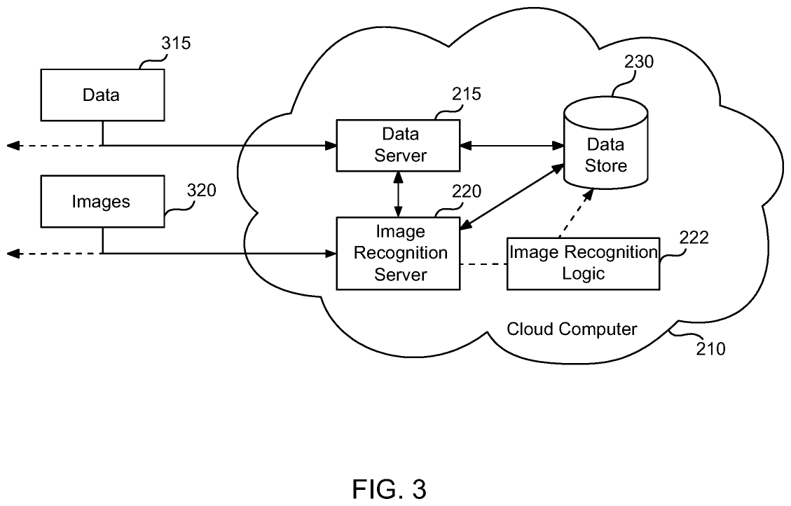

The mobile computing device 100 is generally configured to communicate with a cloud computer 210. As depicted in FIG. 3, data 315 and/or images 320 may be communicated between the mobile computing device 100 and the cloud computer 210. In some embodiments, the cloud computer 210 may optionally include one or more of a data store 230, data server 215, or image server 220. In some embodiments, the data server 215 and image server 220 are a single server. In some embodiments, the data server 215 and image server 220 are separate servers. The data server 215 and image server 220, whether combined or separate, may generally communicate images and/or other data to a data store 230. In additional embodiments, the cloud computer 210 may comprise image recognition logic 222 in communication with the image server 220 and data store 230. In various embodiments, the image recognition logic 222 may extract data 315 from one or more lottery ticket images 320 for storage in the data store 230 or for communication back to the mobile computing device 100. In various embodiments, the lottery ticket images 320 may include front and back images which are associated to one another. In various embodiments, the image server, image recognition logic, and/or data store 230 may provide for maintaining the association of the front and back images along with any accompanying data 315. The cloud computer 210 may also associate any lottery-ticket specific images 320 and data 315 with a user account.

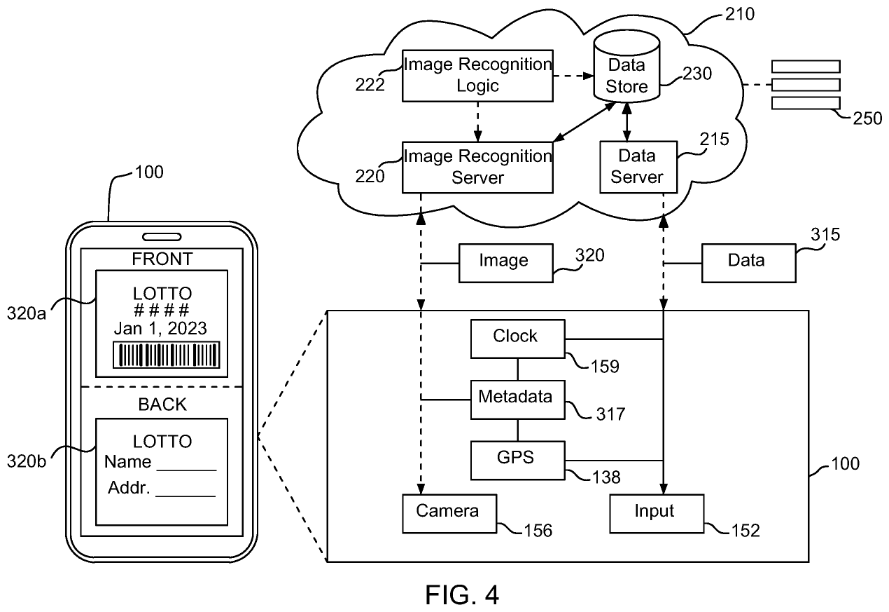

FIG. 4 depicts an exemplary embodiment of a mobile computing device 100 depicting front 320a and back 320b image of a lottery ticket. In an embodiment, both front 320a and back 320b images of the lottery ticket are collected for proof-of-ownership. The mobile computing device 100 may include a camera 156 for collecting said front and back images 320. In an embodiment, the camera 156 of the mobile computing device may be accessed through the lottery application 116 such that any captured image may be directly loaded into the application. In an alternative embodiment, the user may capture one or more photos using a different application and load images from the data store 106 of the mobile computing device 100 to the application 116.

The images 320a. 320b, may be stored with associated metadata, or may have certain metadata associated in the application 116. Alternatively, the “metadata” may be transmitted as or with separate packets of data 315 which the system associates with the image file(s). the “metadata” 317 generally refers to any image-specific data including the time at which the photo was taken from the clock 159, and optionally the GPS location of where the photo was taken 138. Any time and GPS information (i.e. proof-of-location data) may be collected from the lottery application 116, or taken from the image data on the mobile computing device data store 106.

In alternative embodiments, the application 116 may provide or prompt the user with a dialogue box for entering information about the lottery ticket. For example, the dialogue box may prompt the user to enter information including one or more of date and time of the lottery ticket purchase, location of the lottery ticket purchase, and cost of the purchase. Advantageously, the application may require all of this information to be entered as soon as the lottery ticket images are taken or uploaded. All of this information may be manually entered or pieces of the information may be taken from or verified by components of the mobile computing device including but not limited to its GPS and clock. This information may be used to further verify that the lottery ticket stored in the application is valid and redeemable if it is a winning ticket.

In an embodiment as exemplified in FIG. 4, the images 320 and any metadata 317 are transmitted to a cloud computer 210 as images 320 and/or data 315. The cloud computer 210 generally communicates with the mobile computing device 100 during and after the user has logged into their account. In an embodiment, the images are transmitted to an image server 220 of the cloud computer. In an embodiment, the image server 220 stores the images in the data store 230. In an alternative embodiment, the image server 220 or another server uses image recognition logic 222 to extract one or more pieces of information from a lottery ticket image. Generally, the extracted information may encompass the lottery numbers, the name/identification of the lottery, the sale date, the drawing date, and any other desired information. In an embodiment, the information includes an identification of the lottery, the sale and/or drawing date, and the lottery numbers. In an alternative embodiment, the user provides as input 152 one or more pieces of lottery ticket information, such as the identification of the lottery, the lottery numbers, and/or the sale or drawing date. Generally, the information provided either as data 315 or extracted from images by the image recognition logic 222, should be sufficient for the systems and methods to determine whether the ticket is a winner for a given lottery drawing.

The image recognition logic 222 may utilize various functions to extract lottery ticket information from images 320. In an embodiment, the logic 222 may use optical character recognition (OCR). In an embodiment, the logic 222 may include connection to an external server for retrieval of the lottery ticket information based upon a barcode or other identifier. The external server may be an official lottery server. The extracted lottery ticket information may be stored on a data store 220 of the cloud computer. Alternatively, the extracted lottery ticket information may be stored on the mobile computing device 100. In an embodiment, the user may manually enter lottery ticket information and the image recognition logic 222 may verify the user-entered information against the ticket images.

The cloud computer may further connect to an external lottery server 250 or other server having lottery information. The cloud computer may receive regularly updated lottery information from the lottery server 250 or may receive lottery information in response to a request sent from the cloud computer 210 to the lottery server 250. Requests may be timed based upon known drawing times. The lottery server 250 may be an official lottery server or may be another server which is updated with official lottery results.

The lottery results may be compared to the one or more lottery tickets associated with the user account. This comparison may be performed in the cloud computer 210 or in the mobile computing device 100. The user (alternatively referred to as player) may be presented with a notification indicating that a lottery result is available. The lottery result may indicate whether the lottery ticket is a wining ticket. The notifications may be automatically sent to other parties based upon pre-set notification settings for the ticket, or alternatively may be forwarded by the user.

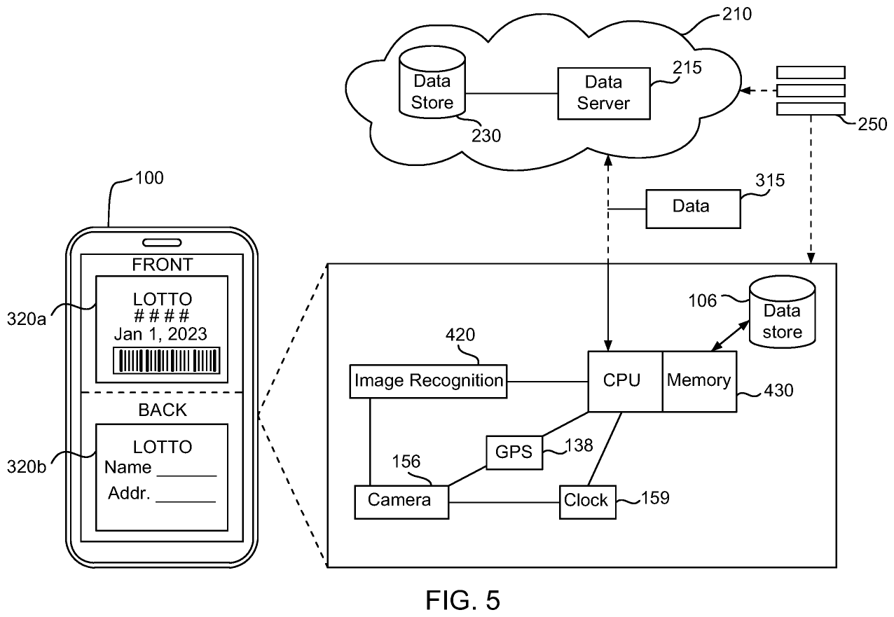

In another embodiment, as exemplified in FIG. 5, the mobile computing device 100 performs one or more aspects instead of cloud computer 210. For example, the mobile computing device may automatically or, upon user input, utilize image recognition 420 on images captured by the camera 156. Images may be captured in the lottery application 116 or another application. In an embodiment, GPS 138 and/or clock 159 information is associated with the one or more images captured by the camera 156. In an alternative embodiment, GPS 138 and/or clock 159 information is associated with the digitized lottery ticket information. As described in the foregoing, GPS 138 and/or clock 159 data may be included in image metadata 317 or may be separate data 315 associated with the lottery ticket(s). In an embodiment, the image recognition 420 in the mobile computing device 100 may alternatively recognize a barcode or QR code on the lottery ticket to access ticket information from a lottery server 250 either directly from the mobile computing device 100 or via an intermediate cloud computer 210. The cloud computer 210, as in other embodiments, may receive image data from the mobile computing device. In an alternative embodiment, the cloud computer 210 receives only data 315 associated with the lottery ticket and user account, with images 320 remaining on the mobile computing device 100. It can be appreciated that mobile computing devices 100 often have their own separate cloud storage solutions (such as iCloud or equivalents) and the data store 106 of the mobile computing device is intended to cover any local or cloud storage of the device 100.

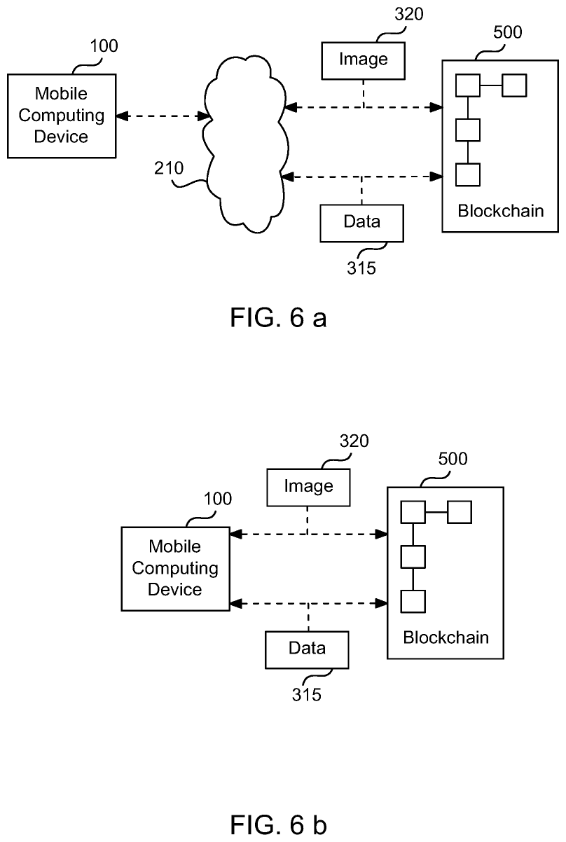

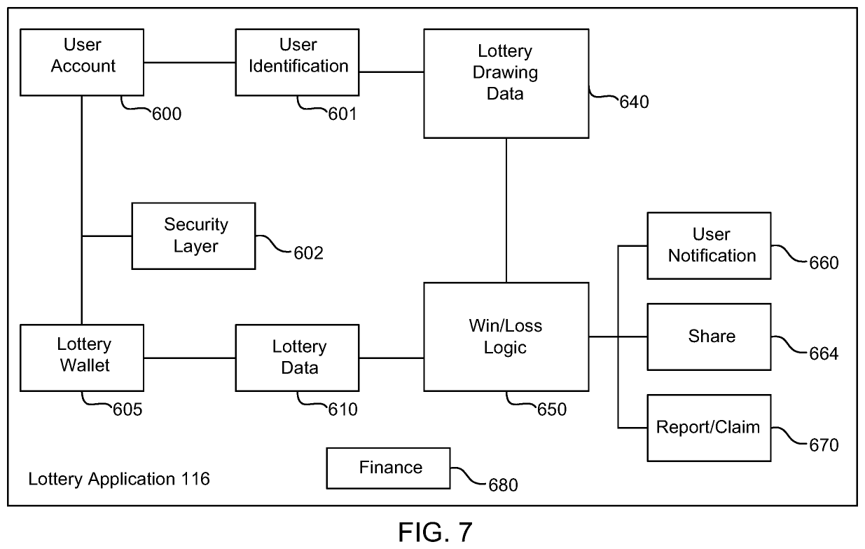

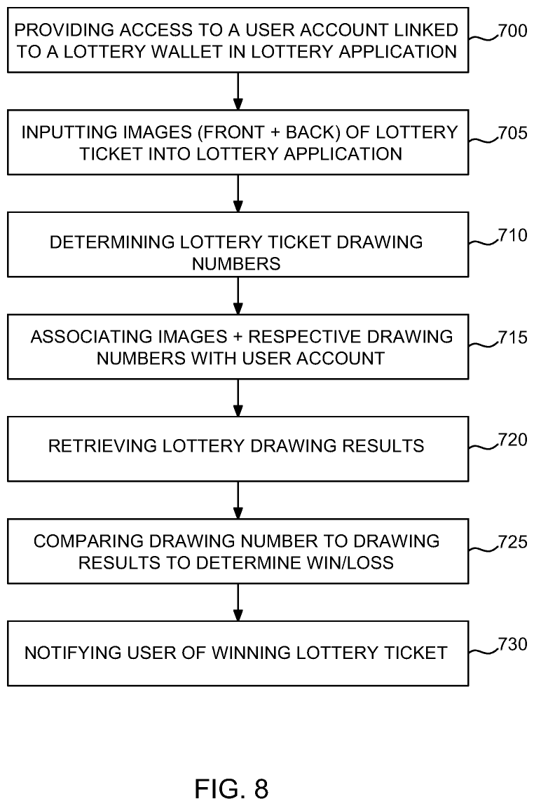

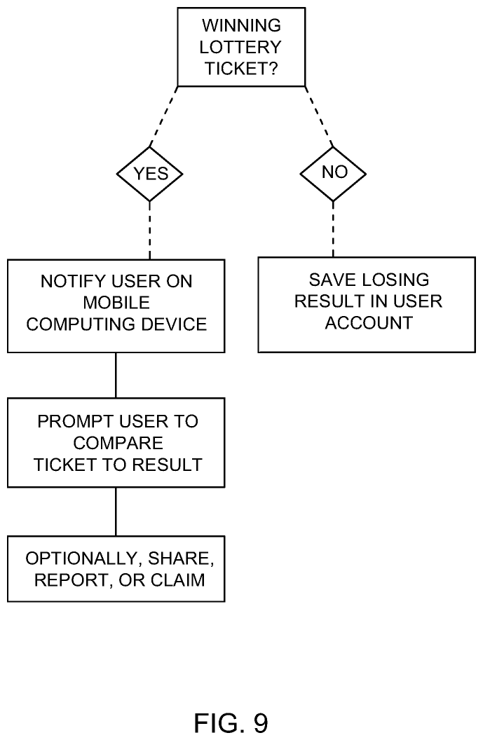

In further embodiments, blockchain storage solutions may be implemented. Blockchain technologies establish provenance and unique ownership of non-fungible tokens (NFTs) associated with a user's digital wallet (which may be in turn associated or linked to their lottery application 116 user account). A non-fungible token may be an image file, such as a .png file, or another type of file storing data extracted from a lottery ticket, or alternatively a different digital representation of the lottery ticket(s). In an embodiment, as exemplified in FIG. 6A, a mobile computing device 100 may communicate with a cloud computer 210 to store image 320 or associated data 315 on a blockchain 500. In an alternative embodiment, as exemplified in FIG. 6B, the mobile computing device 100 may directly interact with a blockchain 500 through web3 or another protocol. Said NFTs may then establish ownership of the lottery ticket by the user for claiming their prize. The image or data stored in the NFT may include clock 159 or GPS 138 data.

In an embodiment, the lottery application 116 performs one or more functions of the systems and methods described herein. It can be appreciated, as described in the foregoing, that various features may be performed on a mobile computing device 100 or cloud computer 210. The lottery application 116 runs on a mobile computing device 100 to allow the user to access their account. The user account 600 is a unique account to the user and is associated with their past lottery tickets, their currently lottery tickets awaiting drawing, and will be associated with future lottery tickets that the user purchases. The user account 600 may be accessed using login credentials, such as a username and password. The user account 600 may be protected by one or more security layers 602. including but not limited to, two-factor authentication, biometric authentication (such as face recognition, fingerprint, etc.), or any other relevant authentication technology. The user account 600 may also be associated with a user identification 601 such as a drivers license or identification card. Such user identification 601 may be optional in some embodiments, or may be suggested to better establish ownership of lottery tickets.

The lottery wallet 605 generally includes all lottery tickets associated with the user account 600. In an embodiment, the user may manually delete losing tickets or losing tickets may automatically be deleted at some pre-set time after the respective drawing. The lottery data 610, including lottery ticket images 320 and other associated data 315, is associated with the tickets in the lottery wallet 605. The application 116 generally provides for a win/loss logic 650 which can determine whether or not a lottery ticket is a winning ticket. It can be appreciated that some lottery tickets contain multiple rows or sets of drawing numbers and it is intended that the application 116 can parse those sets of drawing numbers into separatable wins or losses. The win/loss logic 650 is based upon the lottery data 610 and the lottery drawing data 640 which is obtained from a verified or reliable source (including but not limited to an official lottery server).

Each lottery has different rules for what constitutes a winning ticket. The win/loss logic 650 may utilize pre-loaded rules in the application or system, or alternatively may retrieve rules from an external server.

Once the win/loss logic makes a determination for each set of lottery numbers, the application 116 may automatically or manually perform several functions. The user notification function 660 may automatically notify the user via a push notification, e-mail notification, text notification, phone call, etc. that a lottery ticket is a winning ticket. The user may customize their notifications based upon winning dollar amount if desired. The notification 660 may prompt the user to log in to the application 116 to view the winning tickets. The notification may prompt the user to manually compare the numbers to validate the win. The user may also share 664 lottery ticket results, for example if purchased in a pool. The sharing may be manual, or may be set up to be automatic (that is, other users may receive the same notification that the user receives). This function enables one person in a lottery pool to manage the tickets while others can be assured that they will be notified if the ticket is a winning ticket. Alternatively, each person in a lottery pool could separately store their lottery ticket on their mobile computing device 100 by the application 116.

Some states allow digital or online claiming of lottery winnings at certain dollar amounts. The application 116 may therefore allow for claiming prizes 670. The claimed prizes may be linked to a user's finances 660 such as their checking account or other account which can accept deposits. The application 116 may also provide for reporting functions 670. Generally, confidentiality of the user is important for lottery winners, especially in cases of big prizes. Currently, lotteries become aware of a winning ticket having been sold by reports from the point of sale (POS). However, the POS sale does not confirm that any person is actually in possession of the winning lottery ticket, as it could have been immediately lost, thrown out, etc. A confidential or alternatively non-confidential report 670 by the application 116 would establish that there is a verifiable winner of the drawing having images 320 and data 315 establishing ownership of the lottery ticket. In this manner, even if the ticket is lost or destroyed, it may be established that there was indeed a winning ticket in possession by the user prior the drawing. Therefore, having a lottery ticket in the application 116 prior to a drawing may be enough to establish possession of the winning ticket.

In various alternative embodiments, the point of sale (POS) may have one or more features complementary to or interacting with the systems and methods herein. In an embodiment, the user may scan a code at the POS, or alternatively the POS may scan a code on the user application 116 displayed on the screen of the mobile computing device, to automatically associate the tickets and/or images thereof with the user account 600. Alternatively, the POS may prompt or require the user to load their tickets into the application 116.

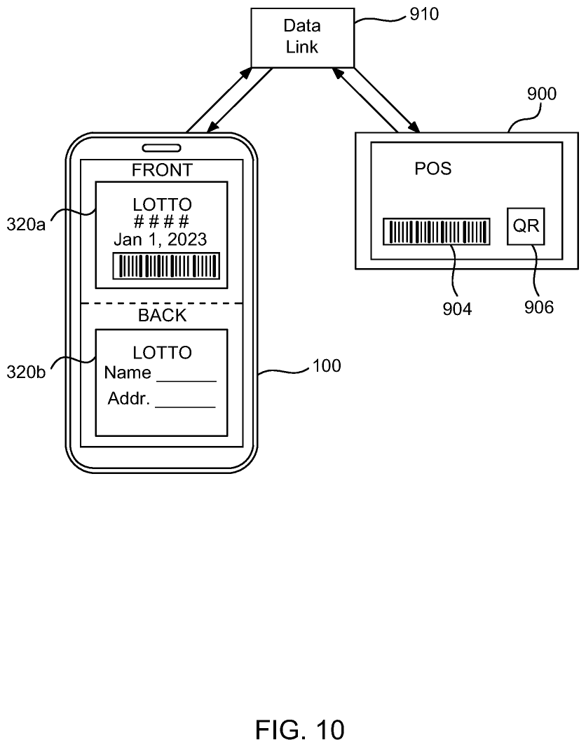

An exemplary system including POS functions is depicted in FIG. 10. A POS location may include a terminal 900. A terminal 900 may be displayed at a consumer-facing front counter, or may be in any other location accessible to the customer or clerk. The terminal 900 will typically have a network connection to one or more data links 910. The data link may include a gateway device, cloud computer, lottery server, data store, or any other useful connection. The data link may include transfer of both images/image data or other data associated with lottery tickets. The data link 910 may alternatively communicate with a lottery server or the terminal 900 may directly communicate with a lottery server.

Systems such as those depicted in FIG. 10 may provide for a convenience consumer experience at the POS. For example, the consumer may enter a POS with their mobile computing device 100 logged into the lottery application 116, or may log into the application while purchasing lottery tickets. The user may indicate to a clerk which tickets they would like to purchase, and the clerk may then use their computer system to generate the tickets. Additionally or alternatively to printing the tickets, the store computer may send information to the terminal 900. The information may include lottery ticket information, images of the paper ticket or digital representations of the ticket, etc. The terminal 900 may provide a barcode 904 or a QR code 906 for the user to scan with their mobile computing device. Once scanned, the lottery application accesses the lottery ticket information by data link 910. After accessing the lottery ticket information, the lottery application on the mobile computing device 100 will have images or digital representations of the lottery tickets saved in the user's lottery wallet as described herein.

The data link 910 may be any number of useful network connections for providing the lottery ticket information to the mobile computing device 100. For example, the mobile computing device, upon scanning the barcode 904 or QR code 906, may access one or more of a cloud computer, a lottery server, or local POS data source (such as the store computer) to obtain the images and lottery ticket information.

In an alternative embodiment, the lottery ticket information is transferred to the mobile computing device but no digital representation or image of the ticket is transferred. Instead, the user may take images using the camera of the computing device, or may be prompted to do so by the lottery application.

In an alternative embodiment, the POS system may not transfer any data to the mobile computing device. In such embodiments, the main function of the POS system may be to provide proof-of-location at the time of ticket purchase. In this manner, by scanning the barcode 904 or QR code 906, the terminal 900 may communicate with a cloud computer or lottery server to establish that the user of the mobile computing device 100 and lottery application 116 was present at the POS at the time that the ticket was sold. This information would then verify that the lottery ticket information/images in the user's lottery wallet were actually purchased by that user. In yet further alternative embodiments, the mobile computing device 100 may provide ID verification to the terminal 900 and/or store computer to further verify the identity and presence of the user. This ID verification may take the place of the clerk needing to separately scan the users ID for age verification. As described herein, the mobile computing device 100 may additionally capture other proof-of-location information such as time/date or GPS location while purchasing lottery tickets, such as prompted by scanning the barcode 904 or QR code 906. Such proof-of-location information may be acquired automatically or manually.

In additional examples, a POS may provide for transferrable ticket image from a scanner or POS computer system. A POS scanner may allow for the user to scan a QR code or other barcode from their mobile computing device camera. Alternatively, a POS scanner may scan a QR code or other barcode displayed on a mobile device from the lottery application. In general, a POS scanner may allow the user mobile computing device to securely download an image or digital representation of a lottery ticket to the lottery application on the mobile computing device. A POS scanner may also interact with the lottery application to take location data for proof of location, or time/date for proof of time of purchase. Such location or time/date may be associated with the user account to provide proof that the user purchased the lottery ticket(s). In alternative embodiments, the lottery application, alone or with POS, could also require user to take a self-photograph in the location having the associated location metadata.

In some embodiments, in addition to store surveillance video if available, the device could provide a location confirming that the customer's phone was at the lottery ticket purchase location at the time of purchase of the lottery ticket. Users of the lottery application could be required to enable location services for such a function. In an embodiment, the location services could update the location based upon a time interval. In an embodiment, the time interval could be variable and more frequent when in proximity to a lottery location. In an embodiment, the locations could have an associated timestamp which the lottery application can reference against the date and time of the lottery ticket. For privacy concerns, the time/location data can be inaccessible to the user and may be deleted after some amount of time, such as weekly or monthly.

In alternate embodiments, the user could manually capture location/time when present at the lottery sales location. Alternatively, the time and location could be captured when the user takes a picture of the lottery tickets. Alternatively, lottery sales locations could send a signal prompt for the application to record a timestamp, by a scanner or wireless signal.

In an embodiment, losing tickets are tracked and expenditures on lottery tickets are tracked. In an embodiment, the expenditures are totaled and offset against winnings to provide a total annual loss. In an embodiment, the total annual loss may be claimed on taxes to offset any potential taxable gains.

In an embodiment, the digital or digitized lottery ticket may replace a paper copy of the ticket. In alternative embodiments, POS locations may provide only a digital copy of the lottery ticket. In an embodiment, the digitized or digital copies are sufficient for claiming the prize for a winning ticket.

In an embodiment, the lottery application provides for digital signing of a lottery ticket. In an embodiment, the back of the lottery ticket is signed for claiming winnings. The lottery application may also allow the user to enter any additional information required such as address, name, telephone number, tax ID or social security number, etc. In an embodiment, this user information is pre-verified by the application. In a further embodiment, the user information may be pre-verified with a state lottery system. In an alternative embodiment. the application may allow for signing the back of the ticket in the presence of a lottery official. In a further embodiment. the application may handle lottery tickets from each state differently so as to comply with the relevant laws and regulations.

What is claimed is:

1. A lottery ticket management system, comprising:
a mobile computing device operable to communicate with a cloud computer;
the cloud computer operable to validate user credentials for access to a user account;
an establishable connection, by one or both of the mobile computing device or cloud computer, to a lottery result server;
an application running on the mobile computing device, the application operable to:
accept user credentials to access a user account;
load, from storage, or capture, from a camera of the mobile computing device, one or more images of a lottery ticket having lottery ticket drawing numbers;
associate the lottery ticket drawing numbers with the user account;
retrieve lottery results from the lottery result server;
determine, by comparing the lottery ticket drawing numbers to the lottery results, whether a lottery ticket number is a winning lottery ticket number; and
notify the user if the lottery ticket drawing numbers are winning numbers.

2. The system of claim 1, wherein the cloud computer including one or more servers configured to receive lottery ticket images or lottery ticket data from the mobile computing device.

3. The system of claim 2, wherein the cloud computer is operable to store lottery ticket images or lottery ticket data in a data store.

4. The system of claim 1, wherein the one or more images of a lottery ticket are associated with a time and date of a clock of the mobile computing device or cloud computer.

5. The system of claim 1, wherein the one or more images of a lottery ticket are associated with a time and date of a clock of the lottery result server.

6. The system of claim 5, wherein a clock of the application and/or cloud computer are synced to a clock of the lottery result server.

7. The system of claim 1, wherein proof of location data from a GPS of the mobile computing device is associated with the images of a lottery ticket.

8. The system of claim 1, wherein the lottery ticket drawing numbers are associated with the user account by optical character recognition of the images, or by accessing a lottery server by a barcode or QR code on the lottery ticket, to obtain lottery ticket data including the lottery ticket drawing numbers.

9. The system of claim 8, wherein the mobile computing device or cloud computer are in communication with a blockchain to store lottery ticket images or lottery ticket data as a non-fungible token associated with a digital wallet of the user, wherein the digital wallet of the user is associated with the user account of the application.

10. The system of claim 8, wherein the lottery ticket data, including the lottery ticket drawing numbers, are stored as image metadata.

11. The system of claim 1, wherein the user account is associated with official user identification (ID card).

12. A method comprising:
providing access to a user account within a lottery application, the lottery application running on a mobile computing device;
inputting one or more images of a lottery ticket for a respective lottery drawing into the lottery application from the mobile computing device or a camera of the mobile computing device;
determining, from the one or more images, lottery ticket drawing numbers
associating respective drawing numbers of the one or more images with the user account;
retrieving lottery drawing results for the lottery drawing;
comparing the lottery ticket drawing numbers to the lottery drawing results to determine whether the lottery ticket is a winning ticket; and
notifying the user if the lottery ticket is a winning ticket.

13. The method of claim 12, wherein the lottery ticket drawing numbers are determined from the one or more images by optical character recognition, or by accessing a lottery server using a barcode or QR code on the lottery ticket.

14. The method of claim 12, wherein the lottery tickets are associated with the user account prior to a lottery drawing to establish ownership prior to the drawing.

15. The method of claim 12, further comprising the step of the user electronically signing an image of the back of the lottery ticket.

16. The method of claim 12, wherein the input images further include one or both of clock or GPS proof of location data.

17. The method of claim 12, further comprising a step of claiming winnings from a winning lottery ticket by communication with a lottery server.

18. A lottery ticket purchasing and management system, comprising:
a mobile computing device operable to communicate with a cloud computer;
a point-of-sale (POS) terminal operable to display a barcode or QR code associated with one or more lottery tickets purchased at the POS;
the cloud computer operable to validate user credentials for access to a user account;
an application running on the mobile computing device, the application operable to:
accept user credentials to access a user account;
scan, from a camera of the mobile computing device, a barcode or QR code displayed on the POS terminal, to associate the user account with the one or more lottery tickets purchased at the POS.

19. The system of claim 18, wherein the application is further operable to:
access from the cloud computer or POS terminal, or capture using the camera of the mobile computing device, one or more images of a lottery ticket having lottery ticket drawing numbers; and
associate the lottery ticket drawing numbers with the user account.

20. The system of claim 19, further comprising a connection, by one or both of the mobile computing device or cloud computer, to a lottery result server.

21. The system of claim 20, wherein the mobile computing device and application are operable to:
retrieve lottery results from the lottery result server;
determine, by comparing the lottery ticket drawing numbers to the lottery results, whether a lottery ticket number is a winning lottery ticket number; and
notify the user if the lottery ticket drawing numbers are winning numbers.

22. The system of claim 18, wherein scanning the barcode or QR code instructs the mobile computing device and application to automatically capture one or more proofs-of-location.

23. The system of claim 22, wherein the proofs-of-location include one or more of time, date, and GPS location.

24. The system of claim 18, wherein scanning the barcode or QR code instructs the mobile computing device and application to automatically transmit a user ID to one or more of a store computer, POS terminal, cloud computer, or lottery server to verify the user's presence at the POS.

25. The system of claim 18, wherein the terminal is a self-service terminal.

26. The system of claim 25, wherein the self-service terminal includes a camera, and wherein the self-service terminal takes an image of the user for proof-of-location at the time of ticket purchase.
